(19) United States
(12) Patent Application Publication
(10) Pub. No.: US 2013/0261376 A1
(43) Pub. Date: Oct. 3, 2013

(54) THERMOTHERAPY DEVICE

(71) Applicant: DRÄGER MEDICAL GMBH, Lübeck (DE)

(72) Inventor: Jochim KOCH, Ratzeburg (DE)

(73) Assignee: Dräger Medical GmbH, Lübeck (DE)

(21) Appl. No.: 13/675,012

(22) Filed: Nov. 13, 2012

(30) Foreign Application Priority Data
Mar. 27, 2012 (DE) 10 2012 006 205.2

(51) Int. Cl. A61G 11/00

(52) U.S. Cl. CPC A61G 11/00
USPC 600/22

(57) ABSTRACT

A thermotherapy device, especially incubator, for the treatment, includes a bordered bed surface freely accessible from above for receiving a newborn. A hood (2) is provided covering the bordered bed surface (4). A heating device (3) is arranged so as to be able to radiate the hood and bordered bed surface. A control and analysis unit is set up to determine the dew point and the temperature at the inner wall of the hood (2), and is also set up to activate the heating device (3) when the temperature at the inner wall of the hood falls below the sum of the dew point and a preset safety margin, and to deactivate the heating device (3) as soon as a temperature determined for the inner wall of the hood reaches a preset value above the dew point.

### CROSS REFERENCE TO RELATED APPLICATIONS

This application claims the benefit of priority under 35 U.S.C. §119 of German Patent Application DE 10 2012 006 205.2 filed Mar. 27, 2012, the entire contents of which are incorporated herein by reference.

### FIELD OF THE INVENTION

A thermotherapy device, especially an incubator, for the treatment of newborns with a bordered bed surface freely accessible from above for receiving a newborn, with a hood for covering the bordered bed surface and a heating device, which is arranged so as to be able to radiate the bed surface.

### BACKGROUND OF THE INVENTION

Such a thermotherapy device, which can be operated as an incubator or an open care unit, is known, for example, from DE 20 2005 021 580 U1. The device has a bordered bed surface open at the top for receiving a newborn. A heating radiator is held above the bordered bed surface, such that it can radiate the bed surface or the hood.

In the care of premature infants and newborns in incubators or so-called hybrids (i.e., thermotherapy devices which can be operated both as incubator and with opened hood as an open care unit), a high air humidity is preferably set to prevent high heat losses within the first days of life. A consequence of this is that moisture can condensate on the hood, which, on the one hand, hinders the view, and on the other hand, is undesirable for hygiene reasons, because microorganisms can grow unhindered in moisture.

To prevent condensation on the hood there was, for example, the approach of providing, besides the hood for covering the incubator, an additional heatable hood, which was placed onto the actual hood of the incubator and which had an electrical resistance heating, which was evaporated on a plastic substrate and was transparent to some degree.

This technique was relatively expensive in terms of cost. Moreover, an additional hood had to be placed onto the actual hood, which impaired the view overall.

It has also been suggested to heat the hood directly electrically, for which reference is made to WO 2010/107724 A1. In this case, the heating must be protected against damage in case of mechanical cleaning or contact with the hood. Moreover, the heating output may not exceed an output of 15 VA because of the risk of fire and explosion when using an enriched oxygen atmosphere in the incubator. However, this is not usually sufficient to heat the hood to the extent that no condensation occurs. All technical approaches to insulate the heating, such that the limitations mentioned are overcome are expensive in terms of construction.

A heating means, which heats the newborn on the bed surface with open care, is present anyway in so-called hybrids. With suitable arrangement of heating means and hood, as described, for example, in DE 20 2005 021 580 U1, the heating means may also be used to heat the hood from outside. A continual heating of the hood would be inefficient and uneconomical, however.

### SUMMARY OF THE INVENTION

It is an object of the present invention is to provide a thermotherapy device of the type mentioned in the introduction, so that condensation of moisture on the inner wall of the hood can be efficiently prevented.

According to the invention, a thermotherapy device is provided for the treatment of newborn. The thermotherapy device comprises a bordered bed surface freely accessible from above for receiving a newborn and a hood covering the bordered bed surface, the hood having an inner wall. A heating means is provided for radiating the hood and the bordered bed surface. A control and analysis unit determines a dew point and a temperature at the inner wall of the hood and activates the heating means when the temperature at the inner wall of the hood falls below the sum of the dew point and a preset safety margin. The control and analysis unit deactivates the heating means as soon as the temperature determined for the inner wall of the hood reaches a preset value above the dew point.

According to the present invention, the control and analysis unit of the thermotherapy device is set up in order to determine the temperature on the inner wall of the hood which is derived either by means of direct measurement with a temperature sensor or by means of calculation from other measured quantities, as is explained further below. Furthermore, the control and analysis unit is also set up to determine the dew point of the atmosphere under the hood and to compare it to the temperature of the inner wall of the hood. If the temperature of the inner wall of the hood falls below the sum of the determined dew point and the preset safety margin, the control and analysis unit activates the heating means. The control and analysis unit is also set up to deactivate the heating means as soon as the temperature determined for the inner wall of the hood reaches a preset amount above the dew point.

Three physical parameters are decisive for the dew point of the atmosphere under the hood: 1) The air temperature of the atmosphere under the hood, 2) the relative humidity of the atmosphere under the hood and 3) the ambient temperature outside of the thermotherapy device. The three parameters can be measured by corresponding sensors which are usually present in most thermotherapy devices anyway. From the air temperature of the atmosphere under the hood and the ambient temperature, an average inner wall temperature of the hood can be calculated using a simple linear formula:

T_{hood}(Tₐᵢᵣ)=Tₐᵢᵣ*(1−K_{hood}*(Tₐᵢᵣ−Tₑₙᵥᵢᵣₒₙₘₑₙₜ)),

in which Tₐᵢᵣ is the air temperature under the hood in ° C., Tₑₙᵥᵢᵣₒₙₘₑₙₜ is the ambient temperature in ° C., and K_{hood} is a constructively determinable heat transfer value for the wall of the hood, which can be determined by the heat conduction constant of the hood material and the heat transfers inside and outside in W/m²*K.

The control and analysis unit is set up to activate the heating means when the temperature of the inner wall of the hood is above the dew point by less than a preset safety margin. In a preferred embodiment, the output of the heating means can be set depending on the temperature difference between the temperature of the inner wall of the hood and the dew point.

Laboratory tests have shown that the average hood temperature can be determined with the equation indicated above with a standard deviation of approximately 0.3° C. If a safety margin of approximately 1° C. is applied, for example, for safety, then condensations can be prevented with sufficient certainty.

The dew point T_{dew} can be determined using the so-called Magnus formula, which can be indicated as follows:

$${T}_{dew} ( ϕ , δ ) = \frac{241.2 ln ( \frac{ϕ}{100} ) + \frac{4222.03716 δ}{241.2 + δ}}{17.5043 - ln ( \frac{ϕ}{100} ) - \frac{17.5043 δ}{241.2 + δ}}$$

in which φ is the relative humidity in percent and δ is the air temperature in ° C. under the hood. Thus, the corresponding dew point can be determined by measuring the air temperature by means of a temperature sensor under the hood and measuring the relative humidity of the atmosphere under the hood. To prevent condensations with high probability, the heating means is already activated by the control and analysis unit when it approaches the determined temperature of the inner wall of the hood up to a preset threshold value (safety margin) of the dew point from above.

The present invention is explained below on the basis of an exemplary embodiment in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a schematic lateral view of a thermotherapy device;

FIG. 2 is a schematic lateral view of an alternative thermotherapy device;

FIG. 3 is a diagram showing the dew point and the temperature of the inner wall of the hood as a function of the temperature of the atmosphere under the hood; and

FIG. 4 is a flow chart, which illustrates the mode of operation of the control and analysis unit of the thermotherapy device.

### DESCRIPTION OF THE PREFERRED EMBODIMENTS

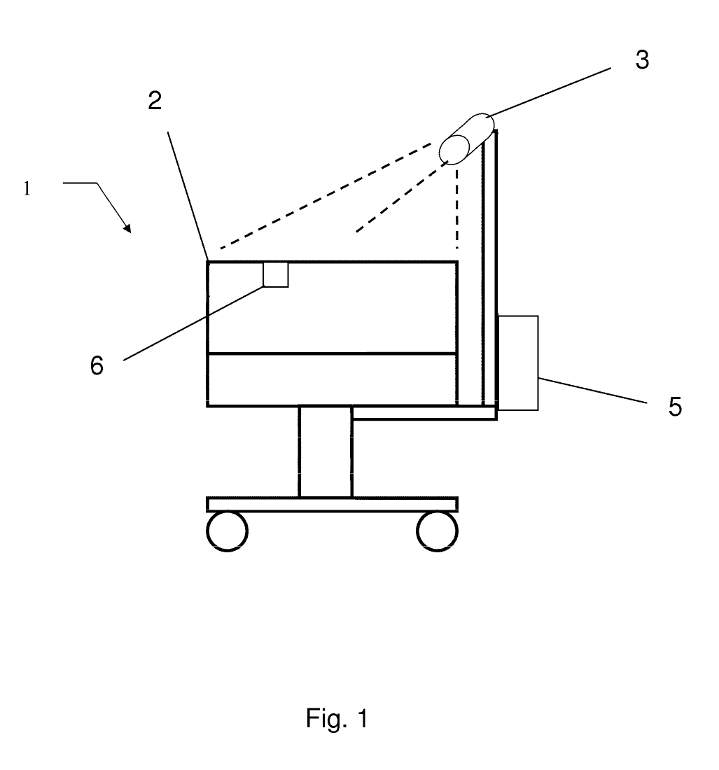

Referring to the drawings in particular, the thermotherapy device 1 schematically shown in FIG. 1 has a bordered bed surface, whereby the bordering (wall structure) can be entirely or partly turned under (moved or pivoted out of a bordering position) when a good accessibility to the bed surface is desired. The bordered bed surface is covered by a removable hood 2. A heating means 3 is mounted above the hood 2. A control and analysis unit 5 picks up a measured value for the temperature of the inner wall of the hood via the sensor 6. The relative humidity of the atmosphere under the hood 2 is detected by a humidity sensor. The control and analysis unit 5 is set up so as to activate the heating radiator 3 as soon as the determined temperature at the hood inner wall drops below a preset value above the dew point.

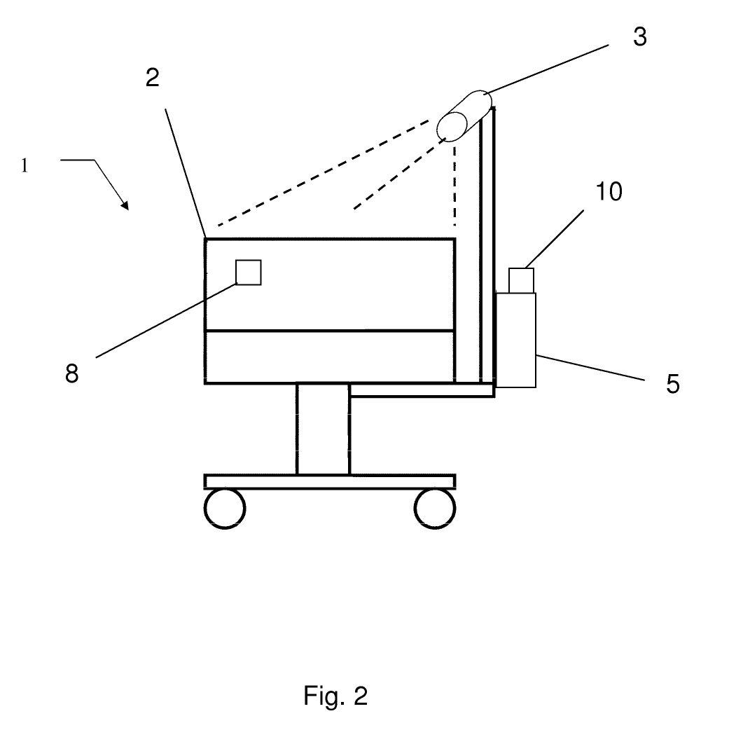

FIG. 2 schematically shows an alternative embodiment of a thermotherapy device 1. Control and analysis unit 5 picks up measured values for the temperature in the environment of thermotherapy device 1 with a sensor 10, the temperature of the atmosphere under the hood 2 and relative humidity of the atmosphere under the hood 2 with a sensor 8. The temperature of the inner wall of the hood can be derived from these measured values using the equation indicated above.

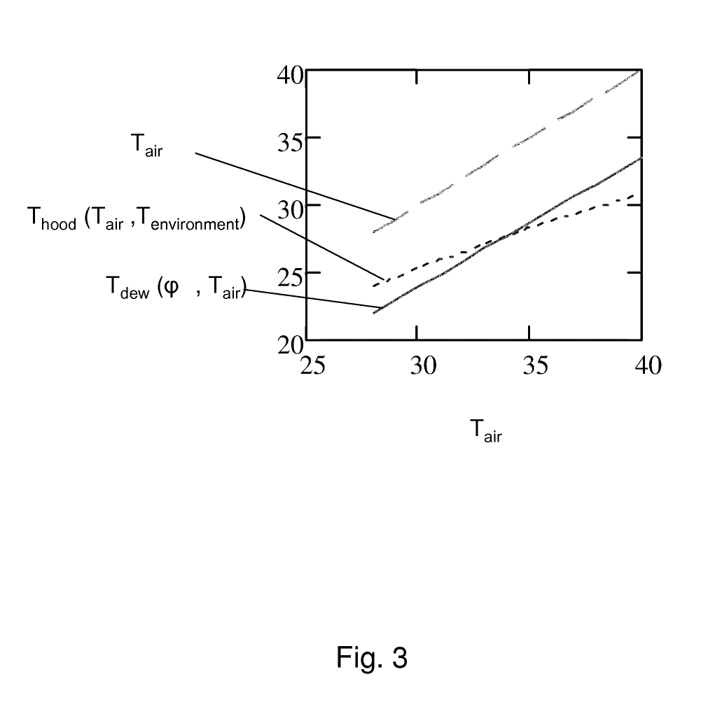

FIG. 3 shows the interrelationship of the temperatures. Basically, the heating radiator should be activated by the control and analysis unit when the determined inner temperature of the hood T_{hood} crosses the dew point T_{dew}. To comply with a safety margin, a threshold value E above the dew point, at which the heating means is already activated, is established.

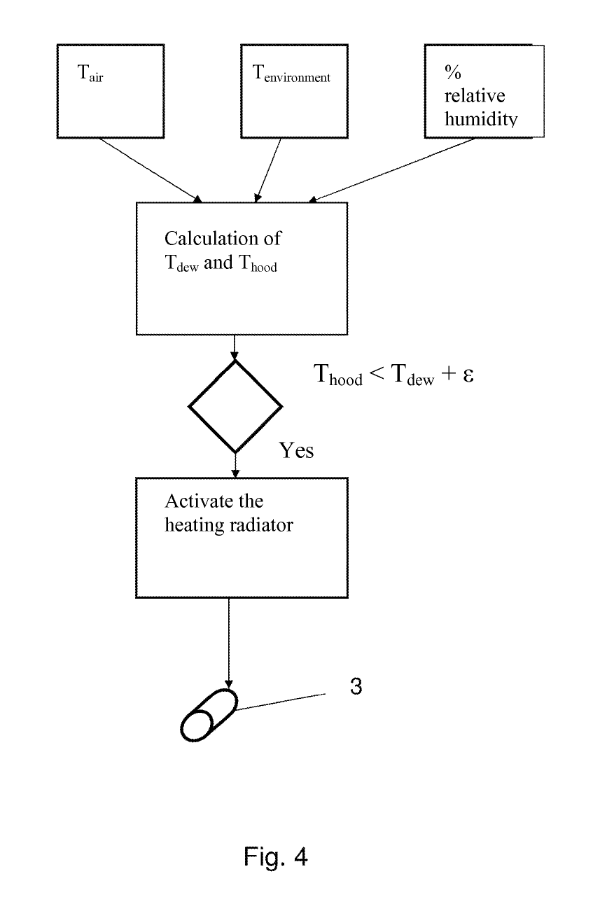

FIG. 4 shows the preprogrammed mode of operation of the control and analysis unit in the form of a flow chart. At first, the dew point is calculated, for example, using the Magnus formula indicated above under the given conditions in the incubator. The temperature T_{hood} of the inner wall of the hood is calculated from the measured values for the temperature under the hood, the temperature in the environment of the thermotherapy device and the relative humidity of the atmosphere under the hood. When the hood temperature T_{hood} lies above the dew point by less than a preset threshold value ε, the heating means is activated in order thereby to keep the temperature of the hood above the dew point. Heating by means of the heating means is continued until the temperature at the inner wall of the hood has increased to a preset value above the dew point.

Calculations of the heat balance of the hood have shown that an output of approximately 60 W is sufficient to keep a hood free from condensations, when the temperature under the hood is 28° C., the ambient temperature is 20° C. and the relative humidity under the hood is 90%. The output of 60 W can be transmitted from the heating radiator to the hood. The heating radiator can be operated at a lower output without an alarm having to be triggered. The standard for radiation heatings IEC 60601-2-21 allows a maximum radiation output of 10 mW/cm² for this without the patient having to be regulated with a skin temperature sensor and an alarm having to be triggered.

A heating radiator with an electric output of 700 W generates a specific radiation output of approximately 50 mW/cm² on the bed surface; for 10 mW/cm², approximately 140 W are necessary then to keep the hood free from condensation in the thermal balance.

On the other hand, the surface temperature of the hood must be prevented from exceeding a maximum value of 43° C. in order to prevent burns in case of contact. At a maximum air temperature of 39° C. in the incubator and an ambient temperature of 30° C. and a radiation output of 10 mW/cm², 43° C. is not exceeded. Thus, a safe operation with an unregulated radiation heating is possible. A fixed output can therefore be preset for the output of the heating radiator to prevent condensations on the hood. Thus, a solution is available which can be implemented in a simple manner without further technical cost (i.e., without additional sensors and heatings). Furthermore, condensation can be prevented by calculating the dew point from the variables and an unnecessary heating of the hood can be prevented at the same time.

While specific embodiments of the invention have been shown and described in detail to illustrate the application of the principles of the invention, it will be understood that the invention may be embodied otherwise without departing from such principles.

What is claimed is:

1. A thermotherapy device for the treatment of newborns, the thermotherapy device comprising:
a bordered bed surface freely accessible from above for receiving a newborn;
a hood covering the bordered bed surface, the hood having an inner wall;
a heating means for radiating the hood and the bordered bed surface; and
a control and analysis unit determining a dew point and a temperature at the inner wall of the hood, and activating the heating means when the temperature at the inner wall of the hood falls below the sum of the dew point and a preset safety margin, and deactivating the heating means as soon as the temperature determined for the inner wall of the hood reaches a preset value above the dew point.

2. A thermotherapy device in accordance with claim 1, further comprising a temperature sensor which detects the temperature at the inner wall and which is connected to the control and analysis unit, the control and analysis unit activating the heating means until the determined temperature at the inner wall of the hood is at a preset value above the dew point.

3. A thermotherapy device in accordance with claim 1, further comprising
a temperature sensor detecting air temperature under the hood;
a temperature sensor detecting environmental temperature in the environment of the thermotherapy device; and
a humidity sensor detecting the relative humidity of the air under the hood, the control and analysis unit determining the temperature by calculating the temperature at the inner wall of the hood based on the air temperature and the ambient temperature and comparing the calculated temperature with the dew point.

4. A thermotherapy device comprising:
a bed surface with a peripheral wall, the bed surface being freely accessible from above for receiving a newborn;
a hood positioned above the bed surface;
a heating device providing radiation directed at the bed surface and the hood disposed between the bed surface and the heating device; and
a control and analysis unit determining a dew point and a temperature at an inner surface of the hood, and activating the heating device when the temperature at the inner surface of the hood falls below a sum of the dew point and a preset safety margin, and deactivating the heating device upon the temperature determined for the inner surface of the hood reaching a preset value above the dew point.

5. A thermotherapy device in accordance with claim 4, further comprising a temperature sensor which detects the temperature at the inner surface of the hood and which is connected to the control and analysis unit, the control and analysis unit activating the heating device until the determined temperature at the inner surface of the hood is at a preset value above the dew point.

6. A thermotherapy device in accordance with claim 4, further comprising
a temperature sensor detecting air temperature under the hood;
a temperature sensor detecting environmental temperature in the environment of the thermotherapy device; and
a humidity sensor detecting the relative humidity of the air under the hood, the control and analysis unit determining the temperature by calculating the temperature at the inner surface of the hood based on the air temperature and the ambient temperature and comparing the calculated temperature with the dew point.
